(19) United States
(12) Patent Application Publication
(10) Pub. No.: US 2003/0147680 A1
(43) Pub. Date: Aug. 7, 2003

(54) Fixing apparatus

(76) Inventors: Takao Kawamura, Sakai (JP); Toshihiro Yukawa, Honjo (JP); Masatoshi Kimura, Kawasaki (JP); Masao Konishi, Kawasaki (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/242,661

(22) Filed: Sep. 13, 2002

Related U.S. Application Data
(63) Continuation of application No. PCT/JP00/01585, filed on Mar. 15, 2000.

(51) Int. Cl. G03G 15/20

(52) U.S. Cl. 399/329; 219/216; 399/333

(57) ABSTRACT

A fixing apparatus comprises a fixing roller, a pressing roller, a third roller disposed in parallel with the fixing roller, and a fixing belt wound around the fixing roller and the third roller. The fixing roller is pressed against the pressing roller via a fixing belt. The third roller or the fixing belt includes a heat generating resistive sheet. The heat generating resistive sheet rapidly heats the fixing belt. The fixing belt efficiently transfers heat to paper. The fixing roller does not need to transfer heat from the inside to the outside. Therefore, an elastic material layer is provided on the surface of the fixing roller.

### CROSS-REFERENCE TO RELATED APPLICATIONS

This application is a continuation of PCT/JP00/01585.

### TECHNICAL FIELD

The present invention relates to a fixing apparatus that is used in a monochrome or a color electronic photographing apparatus.

### BACKGROUND ART

An electronic photographing apparatus such as a copying machine, a facsimile, and a printer, comprises an image formation apparatus and a fixing apparatus that fixes an image that has been formed or transferred onto a sheet of paper by the image formation apparatus. The fixing apparatus comprises a fixing roller and a pressing roller so that a paper is nipped between the fixing roller and the pressing roller and conveyed thereby. Either one of or both of the fixing roller and the pressing roller is formed as a heating roller that incorporates a heating source, thereby to fix the image that has been formed on the paper, with heat or pressure.

For example, FIG. 6 and FIG. 7 show examples of a conventional fixing apparatus. FIG. 6 shows a fixing apparatus that has a fixing roller 1 and a pressing roller 2. A halogen lamp 3 is provided in the fixing roller 1 as a heat source. The fixing roller 1 is made from a metal hollow cylindrical tube, and the pressing roller 2 comprises a metal hollow cylindrical tube and silicone rubber layer 4 that covers this hollow cylindrical tube.

FIG. 7 shows a fixing apparatus that has a fixing roller 1 and a pressing roller 2. A halogen lamp 3a is provided in the fixing roller 1, and a halogen lamp 3b is provided in the pressing roller 2. The pressing roller 2 comprises a metal hollow cylindrical tube and silicone rubber layer 4a that covers this hollow cylindrical tube, and the pressing roller 2 also comprises a metal hollow cylindrical tube and silicone rubber layer 4b that covers this hollow cylindrical tube. The silicone rubber layers 4, 4a, or 4b are pressed against the other roller and are deformed respectively.

These fixing apparatuses have a drawback in that at least any one of three factors of heat conductivity, a nip width, and a paper detaching property that determine the fixing performance. The nip width (N) is a distance between a nip-starting line and a nip-finishing line between the fixing roller 1 and the pressing roller 2, and a detachment angle (P) is an angle formed between a paper discharge direction and a tangent to the fixing roller 1 at the nip-finishing end.

In the fixing apparatus shown in FIG. 6, the fixing roller 1 that works as a heating roller is formed from an aluminum tube with no covering layer thereon, or an aluminum tube with a thin rubber layer covering it. Therefore, in such a fixing roller l, heat conductivity from the fixing roller 1 to the paper becomes good, but the nip width (N) becomes small and the detachment angle (P) also becomes small. When the nip width (N) is small, the time to heat the paper and a toner becomes smaller. This becomes remarkable as the linear speed of the paper becomes faster. Consequently, this has a risk of bringing about cold offset or hot offset of the toner. When the detachment angle (P) is small, there is a risk that the paper after leaving the nip section is adhered to the fixing roller 1.

In the fixing apparatus shown in FIG. 7, as both the fixing roller 1 and the pressing roller 2 have the rubber layers 4a and 4b as thick covering layers respectively, the nip width (N) becomes large and the detachment angle (P) also becomes large. However, when the covering rubber layer 4a of the fixing roller 1 has a large thickness, heat conductivity from the fixing roller 1 to the paper becomes poor, and it takes a long time to raise the surface temperature of the fixing roller 1. Consequently, the follow-up of the surface temperature of the fixing roller 1 based on the heating of the heater 3 is also lowered. Therefore, there has been a problem of the occurrence of hot offset of the toner, and a delay in the fast printing.

To overcome the above difficulties, there have been employed a method of preventing the hot offset by excessively increasing the power of the heat source such as the halogen lamp, and a method of increasing the nip width by increasing the diameter of the fixing roller 1. However, these methods have had further problems in that the power consumption increases and that the fixing apparatus becomes large.

In order to avoid these problems, there have been proposed fixing apparatuses that increase the nip width by winding a fixing belt around the fixing roller and bringing the fixing belt into contact with the pressing roller (for example, Japanese Utility Model Laid-open Publication No. 5-008573, Japanese Patent Laid-open Publication No. 7-219366, Japanese Patent Laid-open Publication No. 9-160405, Japanese Patent Laid-open Publication No. 10-115996, and Japanese Patent Laid-open Publication No. 10-268681). However, even when these methods are employed, considerable time has been required to raise the temperature of the fixing belt to a temperature that is necessary to achieve fixing.

### SUMMARY OF THE INVENTION

The object of the present invention is to solve the above problems, and to provide a fixing apparatus having satisfactory heat efficiency by improving the fixing performance (an enlargement of a non-offset margin area, the color reproducibility and a luster control), improving the paper detachment, shortening the fast printing time, and reducing the energy consumption.

According to one aspect of the present invention, there is provided a fixing apparatus comprising a fixing roller, a pressing roller disposed contactably with the fixing roller, a third roller disposed in parallel with the fixing roller and a fixing belt wound around the fixing roller and the third roller, wherein the third roller includes a base cylindrical layer and a heat generating resistive sheet provided on the surface of the base cylindrical layer, and the fixing roller has a base cylindrical layer and an elastic material layer provided on the surface of the base cylindrical layer.

According to another aspect of the present invention, there is provided a fixing apparatus comprising a fixing roller, a pressing roller disposed contactably with the fixing roller, a third roller disposed in parallel with the fixing roller, and a fixing belt wound around the fixing roller and the third roller, wherein the fixing belt comprises a heat generating resistive sheet, and the fixing roller has a cylindrical tube and an elastic material layer provided on the surface of the cylindrical tube.

In the fixing apparatuses of the above aspects, the fixing apparatus has the fixing roller covered with a heat resistant elastic material, the pressing roller having a smaller elastic deformation than the fixing roller, and the third roller, and the fixing belt is applied to between the fixing roller and the third roller to rotate the fixing roller and the pressing roller by a driving mechanism. The fixing belt is heated by the heat generating resistive sheet of the fixing roller or by the heat generating resistive sheet of the fixing belt itself. The heated fixing belt continuously passes through the contact section (the nip section) between the fixing roller and the pressing roller, and melts and fixes the toner transferred onto the paper, with the heat of the fixing belt.

The heat generating resistive sheet that is used as the heat source of the fixing apparatus includes a sheet-like heat generating resistive layer which is sandwiched by two insulating layers. The heat generating resistive sheet generates heat by conducting current through the heat generating resistive layer. When the current is supplied to the heat generating resistive sheet, the temperature of the heat generating resistive sheet rises rapidly and with good heat efficiency. This heat generating resistive sheet is desirable as the heat source of the fixing apparatus.

When the heat generating resistive sheet is wound cylindrically in a roll shape, this heat generating resistive sheet can be used as the fixing roller or the third roller. When the heat generating resistive sheet is formed in an endless belt shape, this heat generating resistive sheet can be used as the fixing belt. When the fixing belt is a heat generating resistive sheet, the paper is directly heated with the heat generating resistive sheet, and therefore, it is possible to achieve quick fixing, and attain satisfactory heat efficiency of the toner.

By employing the fixing belt heated by the heat generating resistive sheet, it is possible to transfer the heat to the paper efficiently. On the other hand, as the fixing belt is heated, it is not necessary to consider the temperature rise time of the fixing roller as in the case when a heat source is disposed in the fixing roller. Therefore, it is possible to provide a thick elastic material layer on the fixing roller. As a result, it is possible to increase the nip width, and achieve heat supply to the toner with high efficiency. As the heat conductivity is extremely good, and the temperature rise time of the fixing belt becomes short, the fast printing time becomes very short.

It is possible to select metal or a material having smaller elastic deformation than the fixing roller, for the surface of the pressing roller, and therefore, the paper is discharged from the nip section in a state that the fixing roller and the pressing roller are pressed against each other, and in a state that the paper leaving the nip approaches the pressing roller, and the detachment angle of the paper relative to the fixing roller becomes large, and the detachment of the paper is improved remarkably.

As the nip width becomes large, it is possible to make the diameter of the fixing roller smaller. Heat efficiency from the heat generating resistive sheet to the contact section of not-yet-fixed paper is improved, and the fast printing time becomes shorter. Therefore, it is possible to realize on-demand printing. As it is possible to minimize the fixing power in the standby mode, it becomes possible to reduce energy consumption.

Preferably, the thickness of the elastic material layer of the fixing roller is at least 2 mm.

Preferably, the cylindrical tube of the fixing roller comprises a metal tube, and the elastic material layer comprises plastic or rubber.

Preferably, the heat generating resistive sheet is constructed of a sheet having a laminated structure that includes a heat generating resistive layer, a metal layer, and an insulating layer that is disposed between the heat generating resistive layer and the metal layer.

Further, according to a still another aspect of the invention, there is provided a fixing apparatus comprising a fixing roller, a pressing roller disposed contactably with the fixing roller, a third roller disposed in parallel with the fixing roller, and a fixing belt wound around the fixing roller and the third roller, wherein the third roller includes a cylindrical tube and a heat generating resistive sheet provided on the surface of the cylindrical tube, the heat generating resistive sheet having a heat generating resistive layer and electrodes connected to the heat generating resistive layer, and further includes a conductive ring electrically brought into contact with the electrodes of the heat generating resistive sheet, and a portion of the heat generating resistive sheet including the electrodes and the conductive ring are formed in a tapered shape respectively.

Further, according to a still another aspect of the invention, there is provided a fixing apparatus comprising a fixing roller, a pressing roller disposed contactably with the fixing roller, a third roller disposed in parallel with the fixing roller, and a fixing belt wound around the fixing roller and the third roller, wherein the fixing belt comprises a heat generating resistive sheet, the heat generating resistive sheet having a heat generating resistive layer and electrodes connected to the heat generating resistive layer, and further includes a conductive ring electrically brought into contact with the electrodes of the heat generating resistive sheet, and a portion of the heat generating resistive sheet including the electrodes and the conductive ring are formed in a tapered shape respectively.

Further, according to a still another aspect of the invention, there is provided a fixing apparatus comprising a fixing roller, and a pressing roller disposed contactably with the fixing roller, wherein the fixing roller comprises a cylindrical tube and a heat generating resistive sheet provided on the cylindrical tube, the heat generating resistive sheet having a heat generating resistive layer and electrodes connected to the heat generating resistive layer, and further includes a conductive ring electrically brought into contact with the electrodes of the heat generating resistive sheet, and an insulating ring is disposed between the cylindrical tube and the conductive ring.

Further, according to a still another aspect of the invention, there is provided a fixing apparatus comprising a fixing roller, and a pressing roller disposed contactably with the fixing roller, wherein the fixing roller comprises a cylindrical tube, a heat generating resistive sheet provided on the cylindrical tube, and an elastic material layer, the heat generating resistive sheet having a heat generating resistive layer and electrodes connected to the heat generating resistive layer, and further includes a conductive ring electrically brought into contact with the electrodes of the heat generating resistive sheet, and a portion of the heat generating resistive sheet including the electrodes and the conductive ring are formed in a tapered shape respectively.

Further, according to a still another aspect of the invention, there is provided a fixing apparatus comprising a fixing roller, and a pressing roller disposed contactably with the fixing roller, wherein the fixing roller comprises a cylindrical tube, a heat generating resistive sheet provided on the cylindrical tube, and an elastic material layer, the heat generating resistive sheet having a heat generating resistive layer and electrodes connected to the heat generating resistive layer, and further includes a conductive ring electrically brought into contact with the electrodes of the heat generating resistive sheet, and an elastic conductive material is disposed between the electrodes of the heat generating resistive sheet and the conductive ring.

Further, according to a still another aspect of the invention, there is provided a fixing apparatus comprising a fixing roller, and a pressing roller disposed contactably with the fixing roller, wherein the fixing roller comprises a cylindrical tube and a heat generating resistive sheet provided on the cylindrical tube, the heat generating resistive sheet has a heat generating resistive layer and insulating layers disposed at both sides of the heat generating resistive layer, and the heat generating resistive layer has a mesh structure in order to change the distribution of resistance.

### BRIEF DESCRIPTION OF THE DRAWINGS

The present invention is described with reference to the embodiments shown in the drawings, in which:

FIG. 1 is a cross-sectional view of a fixing apparatus according to a first embodiment of the present invention;

FIG. 2 is a cross-sectional view of a third roller shown in FIG. 1 cut along a line II-II in FIG. 2;

FIG. 3 is a view that shows a modification of the fixing apparatus shown in FIG. 1;

FIG. 4 is a cross-sectional view of a fixing apparatus according to a second embodiment of the present invention;

FIG. 5 is a cross-sectional view of a third roller and a fixing belt shown in FIG. 4 cut along a line V-V in FIG. 4;

FIG. 6 is a view that explains a conventional technique;

FIG. 7 is a view that explains another conventional technique;

FIG. 8 is a cross-sectional view of a fixing apparatus according to a third embodiment of the present invention;

FIG. 9 is a cross-sectional view of a third roller and a current feeding unit of the fixing apparatus shown in FIG. 8;

FIG. 10 is a partially-enlarged view of the third roller and the current feeding unit shown in FIG. 9;

FIG. 11 is an end elevation of the current feeding unit observed from the direction of an arrow mark XI in FIG. 10;

FIG. 12 is a view that explains the work of the current feeding unit at the end of the third roller shown in FIG. 9;

FIG. 13 is a view that explains the working of a comparative example;

FIGS. 14A to 14D are views that show steps of assembling the current feeding unit shown in FIG. 8;

FIGS. 15A to 15C are views that show steps of assembling the current feeding unit following the step shown in FIG. 14D;

FIG. 16 is a cross-sectional view of a third roller and a current feeding unit of a fixing apparatus according to a fourth embodiment of the present invention;

FIGS. 17A to 17D are views that show steps of assembling the current feeding unit shown in FIG. 16;

FIGS. 18A to 18C are views that show steps of assembling the current feeding unit following the step shown in FIG. 17D;

FIG. 19 is a cross-sectional view of a third roller and a current feeding unit of a fixing apparatus according to a fifth embodiment of the present invention;

FISG. 20 is a perspective view of the fixing apparatus that includes the third roller and a fixing belt shown in FIG. 19;

FIG. 21 is a cross-sectional view of a fixing apparatus according to a sixth embodiment of the present invention;

FIG. 22 is a cross-sectional view of a fixing apparatus according to a seventh embodiment of the present invention;

FIG. 23 is an enlarged cross-sectional view of a fixing roller and a current feeding unit shown in FIG. 22;

FIG. 24 is a cross-sectional view of a spring ring shown in FIG. 23;

FIG. 25 is a perspective view of the spring ring shown in FIG. 23;

FIG. 26 is a cross-sectional view of a fixing apparatus according to an eighth embodiment of the present invention;

FIG. 27 is an expanded view of a heat generating resistive sheet shown in FIG. 26;

FIG. 28 is a top plan view of a heat generating resistive layer of the heat generating resistive sheet shown in FIG. 27;

FIG. 29 is a cross-sectional view of the heat generating resistive layer shown in FIG. 28;

FIG. 30 is a partially-enlarged cross-sectional view of the heat generating resistive sheet shown in FIG. 29;

FIG. 31 is a schematic perspective view of the heat generating resistive layer of the heat generating resistive sheet shown in FIG. 26;

FIG. 32 is a view that shows temperature distributions of the heat generating resistive sheet; and

FIG. 33 is a view that shows a modification of the heat generating resistive layer.

### BEST MODE FOR CARRYING OUT THE INVENTION

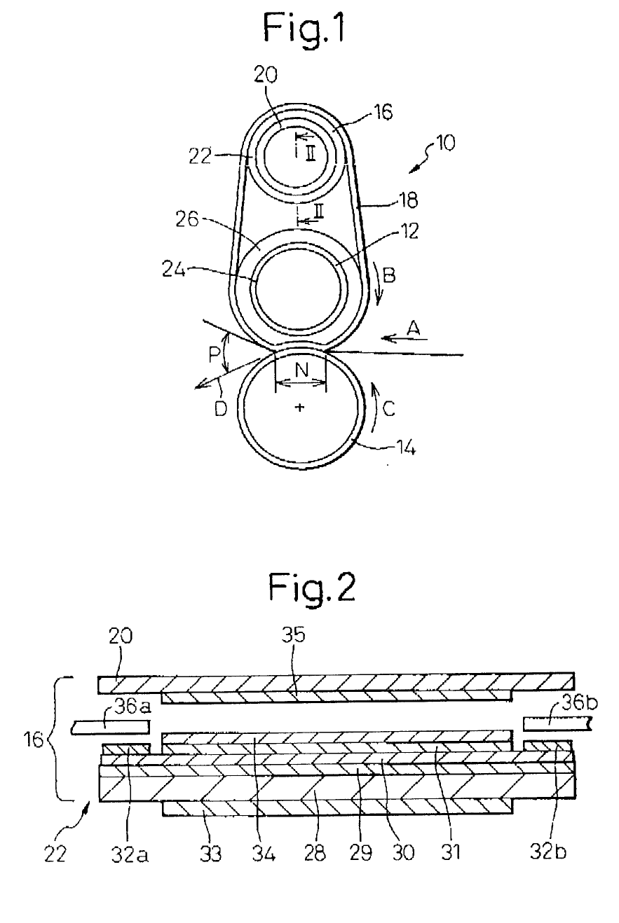

FIG. 1 is a cross-sectional view of a fixing apparatus 10 according to a first embodiment of the present invention. The fixing apparatus 10 is disposed within an electronic photographing apparatus (such as a copying machine, a facsimile, and a printer). The electronic photographing apparatus (such as a copying machine, a facsimile, and a printer), has an image formation apparatus (not shown) for forming (or transferring) an image onto a paper. The paper on which the image is formed or transferred is conveyed from the image formation apparatus to the fixing apparatus 10, as shown by the arrow A, for example.

The fixing apparatus 10 comprises a fixing roller 12, a pressing roller 14 disposed contactably with the fixing roller 12, a third roller 16 disposed in parallel with the fixing roller 12, and a fixing belt 18 wound around the fixing roller 12 and the third roller 16. The third roller 16 includes a cylindrical tube 20 and a heat generating resistive sheet 22 provided on the surface of the cylindrical tube 20.

The fixing belt 18 is rotated together with the fixing roller 12 and the third roller 16, in the direction of the arrow B. For this purpose, it is possible to drive the fixing roller 12, or it is possible to drive the third roller 16. The fixing roller 12 and the pressing roller 14 are pressed against each other. The pressing roller 14 is rotated with the fixing roller 12 and the fixing belt 18 and rotates in the direction of the arrow C.

Paper is passed into a nip section between the fixing roller 12 and the pressing roller 14, in the direction of the arrow A, and is discharged from the nip section in the direction of the arrow D. The fixing belt 18 is heated by receiving heat which the heat generating resistive sheet 22 of the third roller 16 generates. As the fixing belt 18 covers the fixing roller 12 at the nip section between the fixing roller 12 and the pressing roller 14, the fixing belt 18 is brought into contact with the paper at the nip section.

The paper passing through the nip section in the direction of the arrow A has information formed or transferred on the surface of the paper that faces the fixing roller 12 side, that is, the fixing belt 18 side. Therefore, the information formed on the paper is fixed with the heat of the fixing belt 18 and the pressure applied to between the fixing roller 12 and the pressing roller 14.

The fixing roller 12 has a cylindrical tube 24 and a heat resistant elastic material layer 26 provided on the surface of the cylindrical tube 24. The pressing roller 14 is made of a material having smaller elastic deformation than the fixing roller 12. Therefore, when the fixing roller 12 and the pressing roller 14 are pressed against each other, the elastic material layer 26 of the fixing roller 12 is deformed considerably, but the pressing roller 14 is not substantially deformed.

The nip width (N) is a distance from a nip-starting line to a nip-finishing line between the fixing roller 12 and the pressing roller 14. The detachment angle (P) is an angle formed between the paper discharge direction D and a tangent to the fixing roller 12 at the nip-finishing end. As the fixing roller 12 includes the elastic material layer 26, the nip width (N) becomes large. When the nip width (N) becomes large, the period of time while the paper is in contact with the heated fixing belt 18 becomes long. The discharge direction of the paper becomes close to the pressing roller 14 as shown by the arrow D, and the detachment angle (P) relative to the fixing roller 12 becomes large. When the detachment angle (P) becomes large, it is possible to solve the problem that the paper discharged from the nip section is adhered to the fixing roller 12 and the fixing belt 18.

FIG. 2 is a view showing details of the third roller 16. The third roller 16 includes the cylindrical tube 20 and the heat generating resistive sheet 22 provided on the surface of the cylindrical tube 20. Although the heat generating resistive sheet 22 is separated from the cylindrical tube 20 to facilitate the explanation in FIG. 2, the heat generating resistive sheet 22 is bonded to the surface of the cylindrical tube 20, in a cylindrical shape.

The heat generating resistive shoot 22 comprises a metal layer 28 made of stainless steel having a thickness of 0.1 mm, an insulating layer 29 made of polyimide having a thickness of 5 to 20 μm, a heat generating resistive layer 30, an insulating layer 31 made of polyimide, and electrodes 32a and 32b. The heat generating resistive layer 30 is sandwiched between the insulating layers 29 and 31, and the metal layer 28 is disposed on the outside of this sandwich structure.

A releasing layer 33 made of silicone rubber is disposed on the outside of the metal layer 28, and a releasing layer 34 made of an Ni electroformed member is disposed on the outside of the insulating layer 31. The cylindrical tube 20 of the third roller 16 is made from an aluminum hollow tube having a diameter of 20 mm and a thickness of t=3 mm. An insulating layer 35 of a fluoride-coated layer is disposed on the surface of the cylindrical tube 20. Further, conductive rings 36a and 36b are disposed in contact with the electrodes 32a and 32b, respectively. The electrodes 32a and 32b are connected to the power source via the conductive rings 36a and 36b, respectively. The releasing layers 33, 34, and 35 are provided optionally.

The heat generating resistive layer 30 may be provided as a film that has a conductive paste containing metal powders or carbon powders coated on an insulating film. Alternatively, the heat generating resistive layer 30 may be provided as a resistive film that has predetermined electric resistance. For example, the heat generating resistive layer 30 contains a matrix of 50 weight percent comprising Ag and Ni particles, synthetic resin, and glass, as a heat generating resistive material. The matrix is provided as a conductive paste, which is dried, to form a heat generating resistive layer.

It is possible to form the heat generating resistive layer 30 on the insulating layer 29 formed on the metal layer 28 by screen printing. Further, the insulating layer 31 and the electrodes 32a and 32b are formed on the heat generating resistive layer 30. The heat generating resistive sheet 22 formed in this way is adhered to the cylindrical tube 20 of the third roller 16 with a heat-resistant adhesive via the releasing layers 34 and 35.

The cylindrical tube 24 of the fixing roller 12 is made from an aluminum hollow tube, and the elastic material layer 26 of the fixing roller 12 is made from silicone rubber of a low-hardness type. The elastic material layer 26 has JISA hardness of 18 Hs, and a rubber thickness of t=5 mm. A diameter of the fixing roller 12 is 27 mm. Alternatively, the elastic material layer 26 may be made from a sponge type material and, in this instance, a material having ASKA C hardness of 30 Hs, and a rubber thickness of t=5.5 to 6.5 mm is suitable. It is preferable that the thickness of the elastic material layer 26 of the fixing roller 12 is equal to or greater than 2 mm.

The pressing roller 14 is made from an aluminum hollow tube having a diameter of 27 mm. Alternatively, the pressing roller 14 may be an aluminum hollow tube with thin rubber on the surface thereof. The rubber thickness is t=0 to 1 mm. The rubber has a HFN 3 layer structure.

The cylindrical tube 20 of the third roller 16 is made from an aluminum hollow tube having a diameter of 20 mm, and a thickness of t=3 mm. The heat generating resistive sheet 22 of the third roller 16 is adhered to the cylindrical tube 20. At least one of a heat-shielding layer, a heat-inverting layer, and an insulating layer is provided between the cylindrical tube 20 and the heat generating resistive sheet 22. At least one of an insulating layer, a metal layer, and a releasing layer is provided on the heat generating resistive sheet 22.

The fixing belt 18 has an inner diameter of 50 mm and a width of 340 mm, and has a silicone rubber layer having a thickness of 200 μm with an Ni electroformed layer of a thickness of 30 to 70 μm applied thereto.

In operation, the heat generating resistive sheet 22 of the third roller 16 generates heat by supplying current to the electrodes 32a and 32b. The heat of the heat generating resistive sheet 22 is transferred to the fixing belt 18. The heat of the heated fixing belt 18 is applied to the paper that is conveyed to the nip section between the fixing roller 12 and the pressing roller 14. The toner on the paper is molten and fixed with the heat of the fixing belt 18.

When the heat generating resistive sheet 22 is used as a heat source of the fixing apparatus 10, the temperature of the third roller 16 reaches 150° C. rapidly and, for example, in less than fifteen seconds. When the fixing belt 18 that is heated by the third roller 16 is employed, it is not necessary to heat the fixing roller 12 and, therefore, it is not necessary to consider the temperature rise time of the fixing roller 12 and it is possible to add the thick elastic material layer 26 to the fixing roller 12. Therefore, it is possible to supply heat to the toner with high efficiency, by enlarging the nip width (N). As the nip width (N) increases, it is possible to decrease the diameter of the fixing roller 12. As a result, it becomes possible to obtain the fixing apparatus 10 that has satisfactory heat efficiency.

It is possible to transfer heat from the heat generating resistive sheet 22 to the not-yet-fixed paper efficiently via the fixing belt 18. Therefore, it is possible to shorten the fast printing time, which makes it possible to realize on-demand printing. As a result, it is also possible to minimize the fixing power in the waiting mode of the electronic photographing apparatus, and it is possible to lower the power consumption.

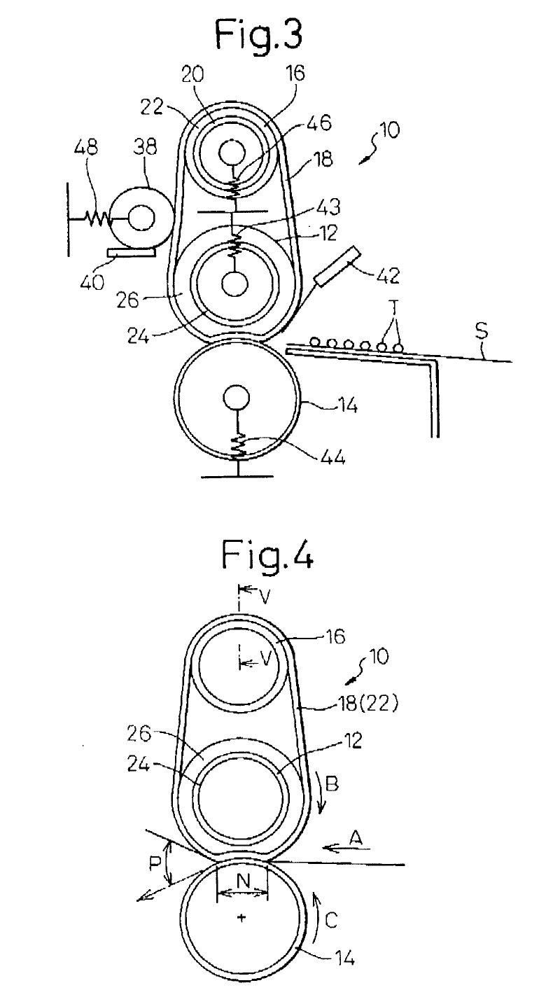

FIG. 3 is a view showing a modification of the fixing apparatus 10 shown in FIG. 1. The fixing apparatus 10 has a fixing roller 12, a pressing roller 14, a third roller 16, and a fixing belt 18. These members are similar to those of the fixing apparatus 10 shown in FIG. 1. In FIG. 3, the fixing apparatus 10 further comprises an oil roller 38, an oil roller cleaner 40, and a thermistor 42. The fixing roller 12 includes an elastic material layer 26, and the third roller 16 includes a heat generating resistive sheet 22. There are also provided springs 42, 44, 46, and 48 that apply spring forces to the rollers 12, 14, 16, and 38, respectively.

The oil roller 38 is pressed against the fixing belt 18 by the spring 48. The oil roller 38 applies oil onto the fixing belt 18, adjusts flexure and tension of the fixing belt 18, and further cleans the fixing belt 18 that may be stained with toner. The oil roller cleaner 40 scrapes off the toner that is adhered to the oil roller 38.

The thermistor 42 is provided in front of the nip section at a position where the thermistor is brought into contact with the fixing belt 18 in order to measure a surface temperature of the fixing belt 18 in a paper conveying direction. The fixing roller 12 and the pressing roller 14 are urged against each other by the springs 43 and 44 that are fitted to the roller shaft of the rollers and the frame of the fixing apparatus 10. The spring 46 that is fitted to the third roller 16 adjusts flexure and tension of the fixing belt 18. The toner T is formed or transferred onto the sheet of paper S which is conveyed such that the toner T faces the fixing roller 12 and the fixing belt 18.

In the third roller 16, the heat generating resistive material is positioned in the vicinity of the roller surface, and therefore, the temperature of the roller surface rises quickly, and heat is transferred to the fixing belt 18 efficiently. The rise of the temperature of a fixing belt 18 is much faster than that of a fixing roller of a conventional fixing apparatuses.

The oil roller 38 is a silflon roller having a diameter of 20 mm. The kind of oil is dimethyl silicone having viscosity of 50 to 100 cs. The amount of oil impregnated in the oil roller 38 is 50 to 90 g. The oil roller 38 cleans any stain off the surface of the belt, and controls flexure and tension of the belt with the spring pressure. A synthetic leather pad or a paper type pad is used for the oil roller cleaner 40 that is brought into contact with the oil roller.

Further, it is possible to achieve a process speed of 57 to 91 mm/s. The drive system is such that the third roller 16 is a driving source of the fixing belt 18. The fixing roller 16 rotates following the rotation of the fixing belt 18, and the pressing roller 14 rotates following the rotation of the fixing belt 18 and the fixing roller 12 with the pressure therebetween.

The temperature efficiency of the heat generating resistive sheet 22 is such that the temperature rises from the normal temperature of 25° C. to a fixing temperature 180° C. in less than 10 seconds at 600 W.

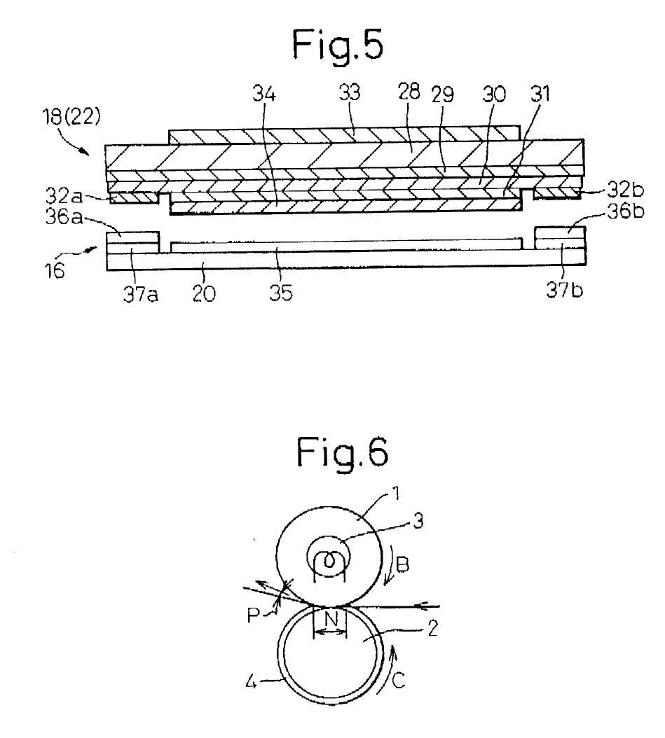

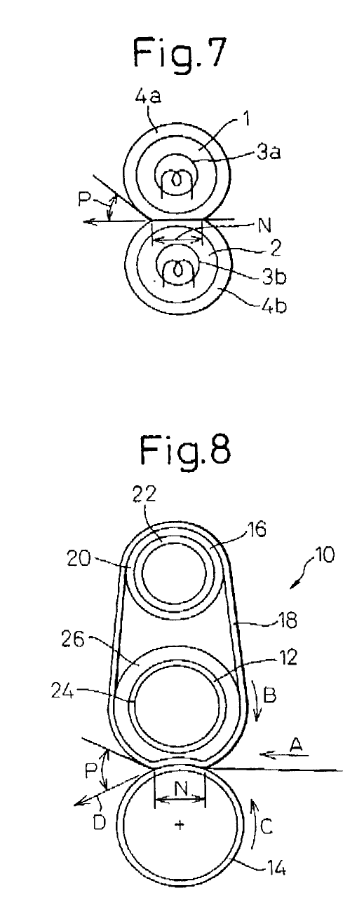

FIGS. 4 and 5 are cross-sectional views of a fixing apparatus 10 according to a second embodiment of the present invention. The fixing apparatus 10 comprises a fixing roller 12, a pressing roller 14 disposed contactably with the fixing roller 12, a third roller 16 disposed in parallel with the fixing roller 12, and a fixing belt 18 wound around the fixing roller 12 and the third roller 16.

In this embodiment, the third roller 16 is made from an aluminum cylindrical tube 20, and the fixing belt 18 comprises a heat generating resistive sheet 22. The fixing roller 12 has a cylindrical tube 24 and a heat resistant elastic material layer 26 provided on the surface of the cylindrical tube 24. The pressing roller 14 is made of a material having a smaller elastic deformation than the fixing roller 12. Therefore, when the fixing roller 12 and the pressing roller 14 are pressed against each other, the fixing roller 12 is deformed more than the pressing roller 14. Consequently, a nip width (N) becomes large, and the period of time while the paper is in contact with the heated fixing belt 18 becomes long. Further, a detachment angle (P) becomes large, and it becomes possible to solve the phenomenon that the paper that is discharged from the nip section is adhered to the fixing roller 12 and the fixing belt 18.

FIG. 5 is a view showing the third roller 16 and the fixing belt 18. The fixing belt 18 is wound around the third roller 16 in use. The third roller 16 comprises a cylindrical tube 20 with an insulating layer 35 of a fluoride-coated layer provided on the surface of the cylindrical tube 20. The heat generating resistive sheet 22 has substantially the same structure as the heat generating resistive sheet shown in FIG. 2.

That is, the heat generating resistive sheet 22 comprises a metal layer 28, an insulating layer 29, a heat generating resistive layer 30, an insulating layer 31, electrodes 32a and 32b, and a releasing layer 33. The heat generating resistive layer 30 is sandwiched between the insulating layers 29 and 31, and the metal layer 28 is disposed on the outside of this sandwich structure.

The releasing layer 33 is disposed on the outside of the metal layer 28, and the releasing layer 34 is disposed on the outside of the insulating layer 31. Conductive rings 36a and 36b are disposed in contact with the electrodes 32a and 32b. The conductive rings 36a and 36b are fitted to the cylindrical tube 20 that constitutes the third roller 16 via insulating layers 37a and 37b. The electrodes 32a and 32b are connected to a power source via the conductive rings 36a and 36b.

The third roller 16 is made from an aluminum hollow tube having a diameter of 20 mm and a thickness of t=3 mm, or an aluminum hollow tube with an insulating layer or non-conductive TEFLON (a registered trademark) coated thereon. The fixing belt 18 has an inner diameter of 50 mm and a width of 340 mm, and a silicone rubber releasing layer 34 having a thickness of 200 μm is adhered to the insulating layer 31 of the heat generating resistive sheet 22. The heat generating resistive sheet 22 has at least one of a heat-reflecting layer, a heat-shielding layer, and a metal layer.

The heat generating resistive sheet 22 is formed in a loop shape or an endless-belt shape, and becomes the fixing belt 18 itself. As the fixing belt 18 becomes a heating unit, the surface temperature of the fixing belt 18 rises rapidly. Therefore, the temperature rise time of the fixing apparatus shown in FIG. 4 is faster than the temperature rise time of the fixing apparatus shown in FIG. 1, under the same power consumption. In this fixing apparatus 10, heat transferring efficiency from the fixing belt 18 to the paper is extremely good, and the temperature rise time of the fixing belt 18 becomes shorter, and therefore, the fast printing time becomes very short, which makes it possible to realize quick fixing and an improved heat efficiency of the toner.

It is apparent that the oil roller 38, the oil roller cleaner 40, the thermistor 42, and the springs 43, 44, 46, and 48 of the fixing apparatus of FIG. 3 can be equipped in the fixing apparatus of FIG. 4.

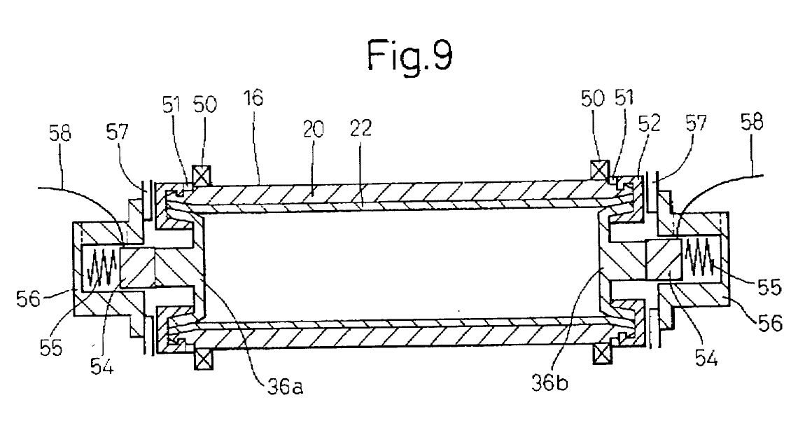

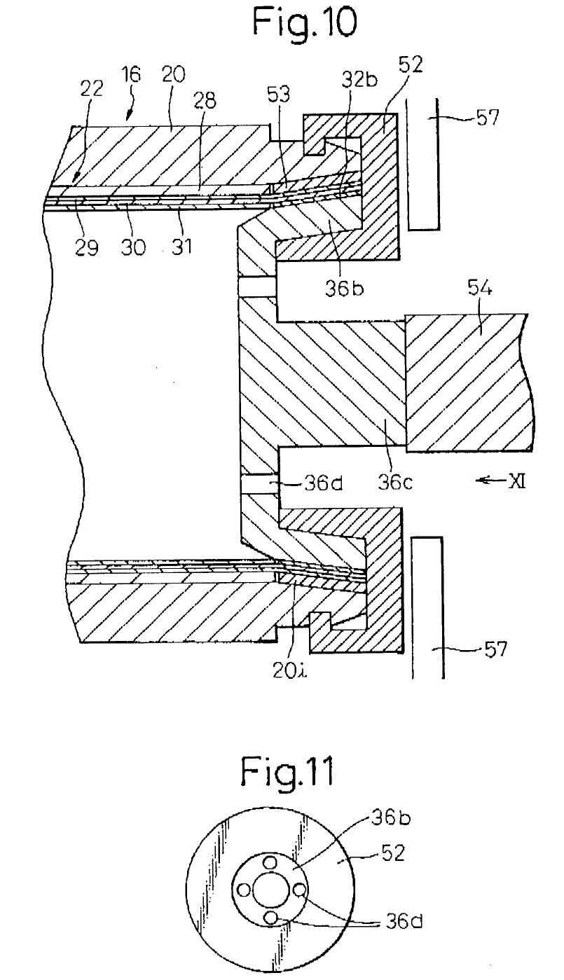

FIG. 8 is a cross-sectional view of a fixing apparatus according to a third embodiment of the present invention. FIG. 9 is a cross-sectional view of a third roller and a current feeding unit of the fixing apparatus shown in FIG. 8. FIG. 10 is a partially enlarged view of the third roller and the current feeding unit shown in FIG. 9. The fixing apparatus 10 of this embodiment has a structure similar to that of the fixing apparatus 10 shown in FIG. 1. That is, the fixing apparatus 10 comprises a fixing roller 12, a pressing roller 14, a third roller 16 disposed in parallel with the fixing roller 12, and a fixing belt 18 wound around the fixing roller 12 and the third roller 16.

The third roller 16 includes a cylindrical tube 20 and a heat generating resistive sheer 22 provided on the surface of the cylindrical tube 20. While the heat generating resistive sheet 22 is provided on the external surface of the cylindrical tube 20 in the first embodiment shown in FIG. 1, the heat generating resistive sheet 22 is provided on the internal surface of the cylindrical tube 20 in this embodiment. The fixing roller 12 has a cylindrical tube 24 and a heat resistant elastic material layer 26 provided on the surface of the cylindrical tube 24. The pressing roller 14 is made of a material having smaller elastic deformation than the fixing roller 12. Therefore, the operation of this embodiment is basically similar to that of the embodiment shown in FIG. 1.

The heat generating resistive sheet 22 comprises a metal layer 28, an insulating layer 29, a heat generating resistive layer 30, an insulating layer 31, and electrodes 32a and 32b (only 32b is shown in FIG. 10). While the releasing layers 33, 34, and 35 shown in FIG. 2 are omitted, it is also possible to provide these releasing layers or other layers.

As shown in FIG. 9, bearings 50 are disposed near both end sections of the cylindrical tube 20 of the third roller 16. The third roller 16 is rotatably supported by the bearings 50. Retaining rings 51 are disposed on the cylindrical tube 20 on the outside of the bearings 50. Ring-shaped fitting claws 52 having center holes respectively are disposed on the cylindrical tube 20 on the outside of the retaining rings 51. The fitting claws 52 are fitted in grooves formed on the external surface of the cylindrical tube 20, with snap fits.

In FIGS. 9 and 10, the end area 20i on the internal surface of the cylindrical tube 20 of the third roller 16 is formed in a tapered conical shape to have a larger diameter toward the end surface side. The insulating layer 31 of the heat generating resistive sheet 22 has a smaller width than the heat generating resistive layer 30, and the end areas of the heat generating resistive layer 30 are exposed from the insulating layer 31. The electrodes 32a and 32b are formed on the exposed end areas of the heat generating resistive layer 30. The metal layer 28 has a smaller width than the insulating layer 29.

The end section of the metal layer 28 is located at substantially the same position as the inside starting point of the end area 20i on the internal surface of the cylindrical tube 20. A tapered insulating ring 53 is disposed along the end area 20i on the internal surface of the cylindrical tube 20. The end section of the metal layer 28 and the end section of the insulating ring 53 share substantially the same boundary. The electrodes 32a and 32b are in the area of substantially the same length as that of the end area 20i on the internal surface of the cylindrical tube 20.

The external peripheral surfaces of the conductive rings 36a and 36b are formed in the same tapered conical shapes as those tapered shapes of the end areas on the internal surface of the cylindrical tube 20 respectively. Therefore, when the conductive rings 36a and 36b are pushed into the cylindrical tube 20 in the axial direction respectively, the conductive rings 36a and 36b are brought into secure contact with the electrodes 32a and 32b respectively. When the conductive rings 36a and 36b have been brought into contact with the electrodes 32a and 32b respectively, the fitting claws 52 are fitted to the cylindrical tube 20. Then, the conductive rings 36a and 36b are held by the cylindrical tube 20, and can rotate together with the cylindrical tube 20.

The conductive rings 36a and 36b have projections 36c at the centers of the external end surfaces. Air holes 36d are provided around the projections 36c. A conductive member 54 is disposed to be pressed against the projection 36c of the conductive ring 36a or 36b by a spring 55 respectively. The conductive member 54 and the spring 55 are held by a holder 56. Each holder 56 is fixed to a frame 57 of the fixing apparatus 10. The conductive member 54 is connected to a power source (not shown) with a cable 58. Therefore, it is possible to feed current from the power source to the electrodes 32a and 32b via the conductive member 54 and the conductive rings 36a and 36b respectively, in a state that the conductive rings 36a and 36b rotate and the conductive member 54 does not rotate. Based on this, it is possible to make the heat generating resistive layer 30 generate heat. The insulating rings 53 and the fitting claws 52 are made of insulating materials like polyimide.

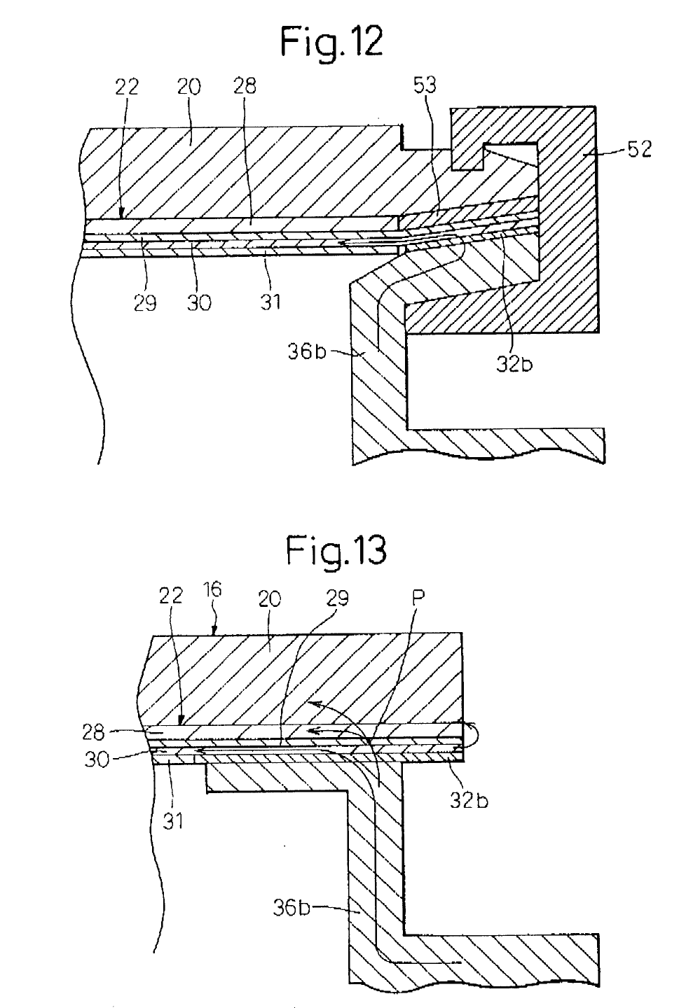

FIG. 12 shows a state that electric current flows from the conductive ring 36b to the heat generating resistive layer 30 through the electrode 32b as shown by the arrow in order to make the heat generating resistive layer 30 generate heat.

FIG. 13 shows a comparative example. In this comparative example, a cylindrical tube 20 of a third roller 16 is formed straight. This cylindrical tube 20 has no tapered end area 20i on the internal surface as shown in FIGS. 9 and 10. The insulating ring 53 is not disposed either. When a conductive ring 36b is brought into contact with an electrode 32b, electric current flows from the conductive ring 36b to the heat generating resistive layer 30 through the electrode 36b as shown by the arrow. Based on this, it is possible to make the heat generating resistive layer 30 generate heat.

When an attempt is made to make the conductive ring 36b engage with the electrode 32b in a state that there is no gap between the conductive ring 36b and the electrode 32b, the electrode is scratched and damaged. When there is a gap between the conductive ring 36b and the electrode 32b, it is necessary to engage the conductive ring 36b with the electrode 32b and to fix the conductive ring 36b and the electrode 32b with an adhesive or the like. Also when the cylindrical tube 20 of the third roller 16 receives stress or vibration, stress is applied to the connecting section between the conductive ring 36b and the electrode 32b, and this connecting section may be damaged.

When electric current is supplied to the heat generating resistive layer 30, a rush of current flows first, and the current gradually falls during heating, and becomes a minimum at a set temperature. When the surrounding of the electrode is not been covered completely at the time when the rush of current flows, a current leakage occurs. As a result, an excessive current is supplied to the cylindrical tube or other conductors, or a thin-film structure of the heat generating resistive sheet 22 is broken. When there is a pinhole P within the heat generating resistive sheet 22, there is a risk that the air within the heat generating resistive sheet 22 expands, and the film is broken.

This embodiment solves the above problems of the comparative example, and it becomes possible to achieve safe and secure supply of current to the heat generating resistive sheet 22 of the rotating cylindrical tube 20, based on the provision of tapers to the cylindrical tube 20 and the conductive rings 36a and 36b respectively. Based on the application of pressing force of the spring 55 to the electrodes, it becomes possible to prevent the inside electrodes from being broken due to stress or vibration. Based on the provision of the insulating rings 53, it becomes possible to avoid leakage of current from the electrode sections to the cylindrical tube 20. Based on the provision of the fitting claws 52 to cover the end surfaces of the cylindrical tube 20 and the heat generating resistive sheet 22, it becomes possible to avoid leakage of current from the heat generating resistive layer 30 to the metal layer 28 and the cylindrical tube 20.

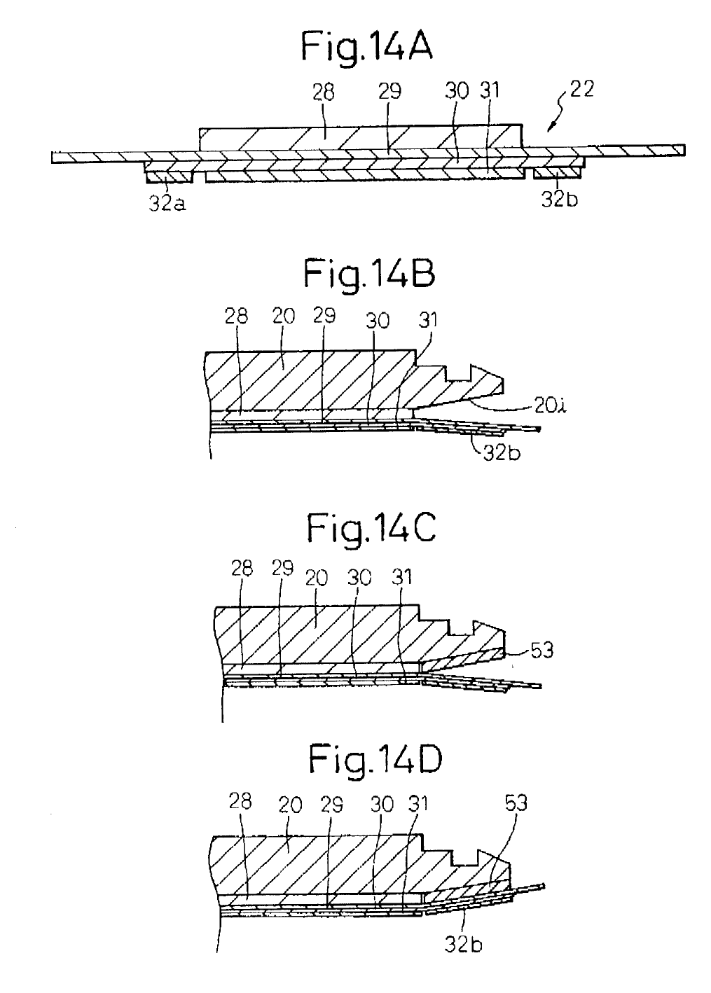

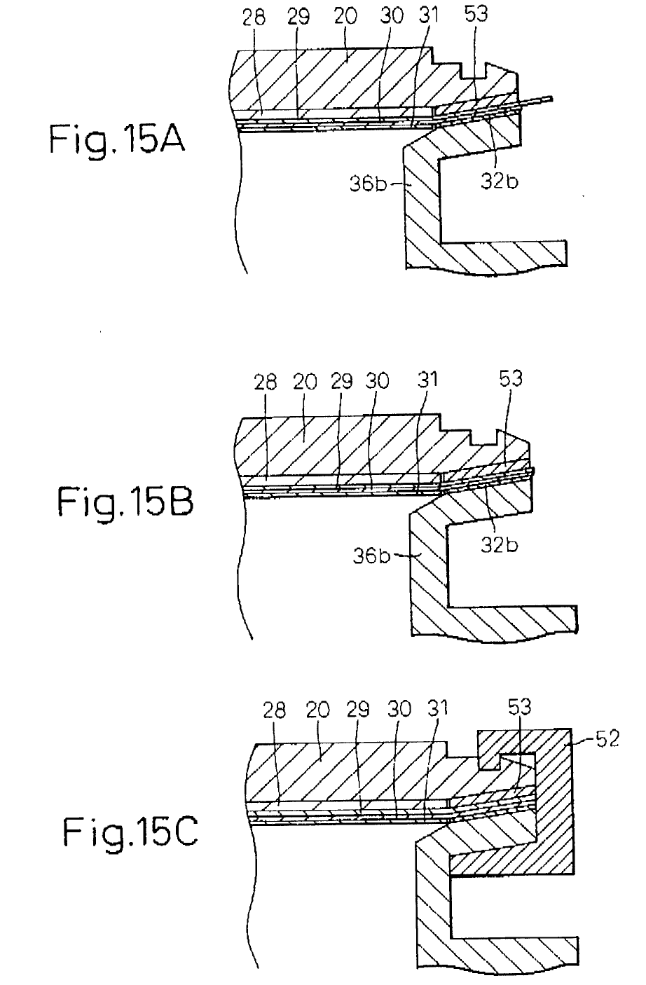

FIGS. 14A to 14D are views showing assembling steps of the current feeding unit shown in FIG. 8. FIGS. 15A to 15C are views showing assembling steps of the current feeding unit following the step shown in FIG. 14D. In FIG. 14A, the heat generating resistive sheet 22 is prepared, and the width of each layer of the heat generating resistive sheet 22 is set. Particularly, the width of the insulating layer 29 is set larger than the widths of the metal layer 28 and the heat generating resistive layer 30 respectively. In FIG. 14B, the flat plate-like heat generating resistive sheet 22 is rounded in a roll shape, and this is adhered to the internal surface of the cylindrical tube 20. In this case, the metal layer 28 is adhered to the internal surface of the cylindrical tube 20.

In FIG. 14C, the insulating ring 53 is engaged with the end area 20i on the tapered internal surface of the cylindrical tube 20. It is not always necessary to adhere the insulating ring to this area. In FIG. 14D, the end section of the insulating layer 29 of the heat generating resistive sheet 22 is pulled to avoid flexure, and the insulating layer 29 is spread to the insulating ring 53 toward the outside.

In FIG. 15A, the conductive rings 36a and 36b are inserted into both end sections of the cylindrical tube 20, to bring the conductive rings 36a and 36b into contact with the electrodes 32a and 32b. In FIG. 15A, the end section of the insulating layer 29 of the heat generating resistive sheet 22 is pulled to avoid flexure. In FIG. 15B, stretched-out portions of the insulating layer 29 of the heat generating resistive sheet 22 are cut out. In FIG. 15, the fitting claws 52 are fitted. In this way, it is possible to construct the fixing apparatus easily and securely in the manner as described above.

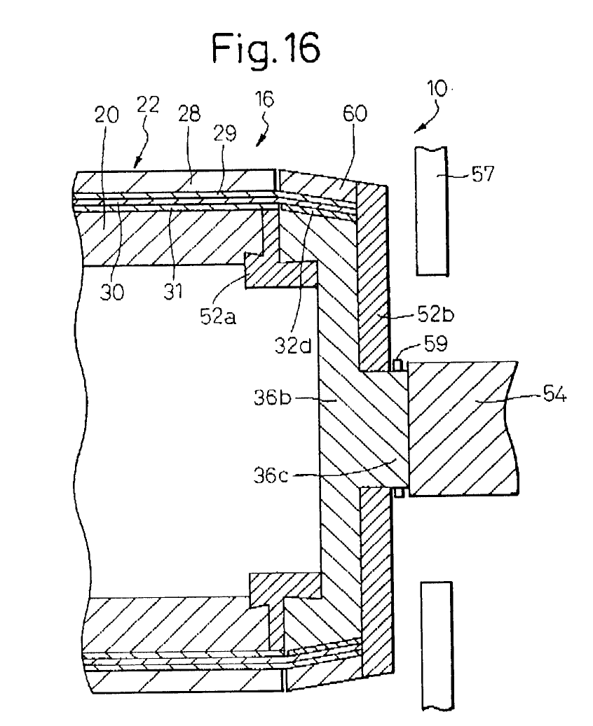

FIG. 16 is a cross-sectional view of a third roller and a current feeding unit of a fixing apparatus according to a fourth embodiment of the present invention. While the heat generating resistive sheet 22 is disposed on the inside of the cylindrical tube 20 of the third roller 16 in the embodiments shown in FIGS. 8 to 10, the heat generating resistive sheet 22 is disposed on the outside of the cylindrical tube 20 of the third roller 16 in this embodiment. The fixing apparatus 10 of this embodiment is similar to the fixing apparatus 10 shown in FIG. 1. That is, the fixing apparatus 10 of this embodiment comprises a fixing roller 12, a pressing roller 14, a third roller 16 disposed in parallel with the fixing roller 12, and a fixing belt 18 wound around the fixing roller 12 and the third roller 16. The third roller 16 includes a cylindrical tube 20 and a heat generating resistive sheet 22 that is provided on the surface of the cylindrical tube 20. The heat generating resistive sheet 22 is provided on the internal surface of the cylindrical tube 20. The fixing roller 12 has a cylindrical tube 24 and a heat resistant elastic material layer 26 provided on the surface of the cylindrical tube 24. The pressing roller 14 is made of a material having smaller elastic deformation than the fixing roller 12. Therefore, the operation of this embodiment is basically similar to that of the embodiment shown in FIG. 1.

The heat generating resistive sheet 22 comprises a metal layer 28, an insulating layer 29, a heat generating resistive layer 30, an insulating layer 31, and electrodes 32a and 32b (only 32b is shown in FIG. 16), It is also possible to additionally provide a releasing layer or other layer. It is also possible to provide bearings like the bearings 50 shown in FIG. 9.

In FIG. 16, the heat generating resistive sheet 22 extends to the outside from the cylindrical tube 20. The externally extending portion of the heat generating resistive sheet 22 is tapered to become narrower in the axial direction from the end section of the cylindrical tube 20 toward the outside. The conductive ring 36b is disposed in contact with the electrode 36b. An insulating ring 60 is disposed on the outside of an insulating layer 29 abuts against the metal layer 28 of the heat generating resistive sheet 22. The conductive ring 36b and the insulating ring 60 are also formed in a similar tapered shape as the externally extending portion of the heat generating resistive sheet 22.

A ring-shaped first fitting claw 52a having a center hole is disposed between the cylindrical tube 20 and the conductive ring 36b on the inside of the heat generating resistive sheet 22, and is fitted in a groove that is formed on the internal surface of the cylindrical tube 20, with a snap fit. Further, a ring-shaped second fitting claw 52b having a center hole is disposed on the outside of the conductive ring 36b, and is fixed to a projection 36c of the conductive ring 36b with a retaining ring 59.

Further, the insulating ring 60 is disposed between the cylindrical tube 28 and the second fitting claw 52b on the outside of the heat generating resistive sheet 22. The conductive member 54 is disposed to be pressed against the projection 32c of the conductive rings 36a and 36b by the spring 55 (refer to FIG. 9) respectively. Air holes 32d are provided around the projection 32c (refer to FIG. 10). The first fitting claw 52a also acts as an insulator, and prevents leakage of current from the conductive ring 36b to the cylindrical tube 20. The insulating ring 60 prevents leakage of current from the electrode 32b and the heat generating resistive layer 30 to the cylindrical tube 28.

In this embodiment, when the first fitting claw 52a, the insulating ring 60, and the conductive ring 36b are pushed into the cylindrical tube 20 in the axial direction respectively, the conductive rings 36a and 36b are brought into secure contact with the electrodes 32a and 32b respectively. The conductive member 54 is connected to a power source (not shown) with a cable (not shown). Therefore, it is possible to feed electric current from the conductive member 54 to the electrodes 32a and 32b through the conductive rings 36a and 36b respectively. Consequently, it is possible to make the heat generating resistive layer 30 generate heat.

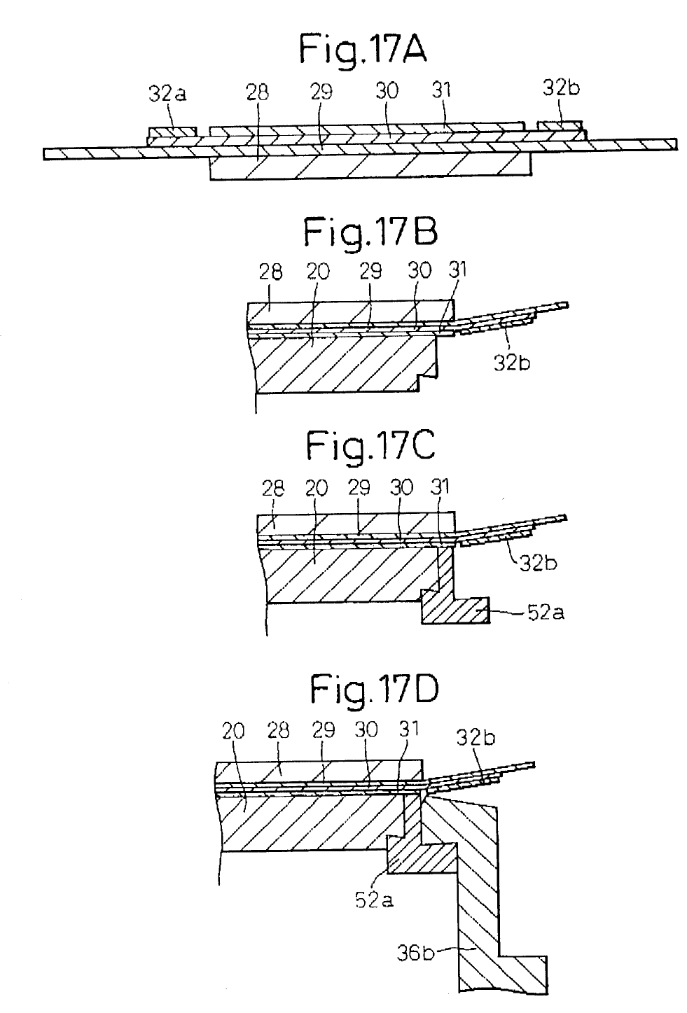

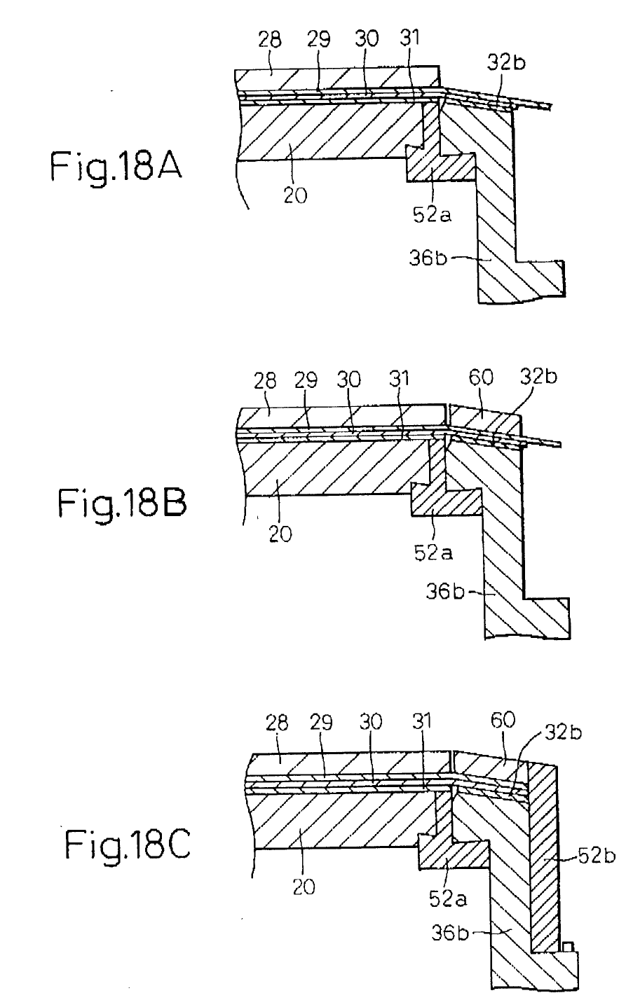

FIGS. 17A to 17C are views showing assembling steps of the current feeding unit shown in FIG. 16. FIG. 18A to FIG. 18C are views showing assembling steps of the current feeding unit following the step shown in FIG. 17D. In FIG. 17A, the heat generating resistive sheet 22 is prepared, and the width of each layer of the heat generating resistive sheet 22 is set. Particularly, the width of the heat generating resistive layer 30 is set larger than the width of the metal layer 28, and the width of the insulating layer 20 is set larger than the width of the heat generating resistive layer 30. In FIG. 17B, the slat plate-like sheet 22 is rounded in a roll shape, and this is adhered to the external surface of the cylindrical tube 20. The insulating layer 31 is adhered to the internal surface of the cylindrical tube 20. The end section of the insulating layer 29 of the heat generating resistive sheet 22 is pulled to avoid flexure, and the insulating layer 29 is spread toward the outside.

In FIG. 17C, the first fitting claw 52a is inserted into the heat generating resistive sheet 22 to bring the first fitting claw 52a into contact with the end section of the cylindrical tube 20. The first fitting claw 52a is fitted in the groove on the internal surface of the cylindrical tube 20, with a snap fit. In FIG. 17D, the conductive ring 36b is inserted into the electrode 32b on the insulating layer 29 of the heat generating resistive sheet 22.

In FIG. 18A, the insulating layer 29 of the heat generating resistive sheet 22 is pressed to the inside toward the surface of the conductive ring 36b, thereby to bring the electrode 32b into contact with the conductive ring 36b. In FIG. 18B, the insulating ring 60 is inserted along the outside of the insulating layer 29 of the heat generating resistive sheet 22, and is brought into contact with the metal layer 28. Thereafter, a surplus portion of the insulating layer 29 of the heat generating resistive sheet 22 is cut out. The electrodes 32a and 32b are brought into secure contact with the conductive rings 36a and 36b. In FIG. 18C, the second fitting claw 52b is pressed against the conductive ring 36b, and end sections of the heat generating resistive sheet 22 and the insulating ring 60 respectively, and a retaining ring 59 (refer to FIG. 16) is engaged with the conductive ring 36b, thereby completing the assembling. In this way, it is possible to securely fit the heat generating resistive sheet 22 to the cylindrical tube without damaging the heat generating resistive sheet 22, and it is possible to securely feed current to the rotating heat generating resistive sheet 22.

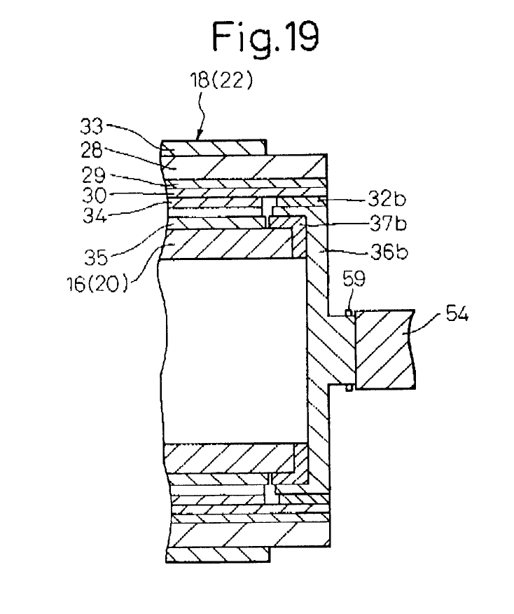

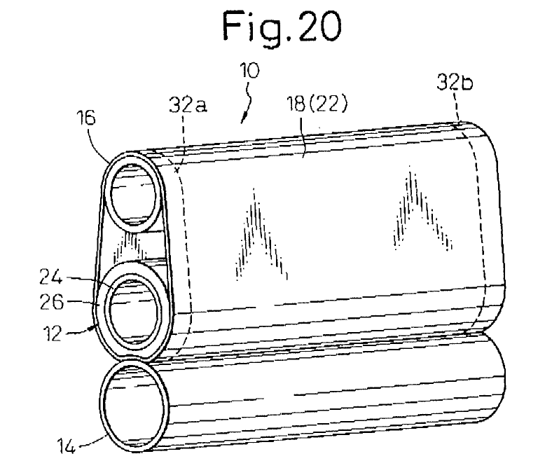

FIG. 19 is a cross-sectional view of a third roller and a current feeding unit of a fixing apparatus according to a fifth embodiment of the present invention. FIG. 20 is a perspective view of the fixing apparatus that includes the third roller and the fixing belt shown in FIG. 19. This embodiment corresponds to a fixing apparatus comprising the fixing apparatuses shown in FIGS. 4 and 5 and a current feeding unit added thereto.

In FIG. 20, the fixing apparatus 10 comprises a fixing roller 12, a pressing roller 14 disposed contactably with the fixing roller 12, a third roller 16 disposed in parallel with the fixing roller 12, and a fixing belt 18 wound around the fixing roller 12 and a third roller 16. The third roller 16 is made from an aluminum cylindrical tube, and the fixing belt 18 comprises a heat generating resistive sheet 22. The fixing roller 12 has a cylindrical tube 24 and a heat resistant elastic material layer 26 that is provided on the surface of the cylindrical tube 24. The pressing roller 14 is made of a material having smaller elastic deformation than the fixing roller 12.

The fixing belt 18 is wound around the third roller 16 when the fixtng belt 18 is in use. The third roller 16 is made from a cylindrical tube 20, and an insulating layer 35 of a fluoride-coated layer is disposed on the surface of the cylindrical tube 20. The heat generating resistive sheet 22 has substantially the same structure as that of the heat generating resistive sheet shown in FIG. 2.

In FIG. 19, the heat generating resistive sheet 22 comprises a metal layer 28, an insulating layer 29, a heat generating resistive layer 30, an insulating layer 31, electrodes 32a and 32b, and a releasing layer 33. The releasing layer 33 is disposed on the outside of the metal layer 28, and the releasing layer 34 is disposed on the outside of the insulating layer 31. Conductive rings 36a and 36b are disposed in contact with the electrodes 32a and 32b. The conductive ring 36b is fitted to the cylindrical tube 20 that constitutes the third roller 16 via the insulating layer 37b. The electrode 32b is connected to a power source via the conductive ring 36b.

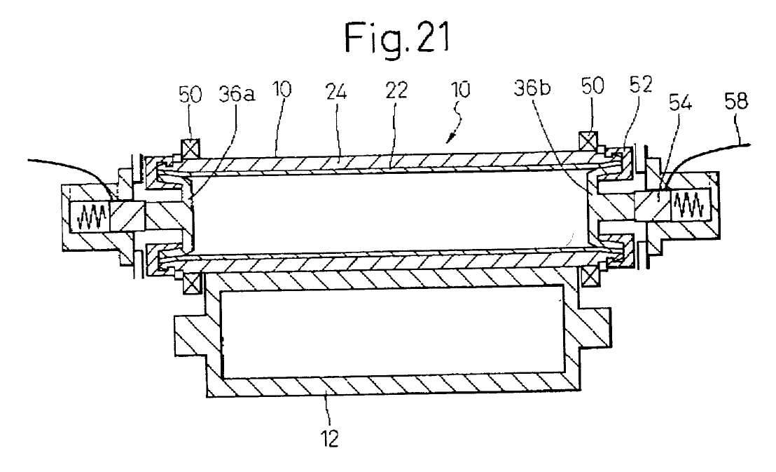

FIG. 21 is a cross-sectional view of a fixing apparatus according to a sixth embodiment of the present invention. The fixing apparatus 10 comprises a fixing roller 12 and a pressing roller 14 disposed contactably with the fixing roller 12. That is, this fixing apparatus 10 does not have the third roller 16 and the fixing belt 18 of the preceding embodiments. In this embodiment, the fixing roller 12 comprises a cylindrical tube 24 and a heat generating resistive sheet 22 provided on the surface of the cylindrical tube 24. The cylindrical tube 24 is rotatably supported to the apparatus by bearings 50.

The heat generating resistive sheet 22 comprises a metal layer 28, an insulating layer 29, a heat generating resistive layer 30, an insulating layer 31, and electrodes 32a and 32b, like the structure shown in FIG. 2, for example. The current feeding unit that feeds current to the electrodes 32a and 32b is similar to that shown in FIGS. 9 and 10. That is, the current feeding unit comprises conductive rings 36a and 36b that can be brought into contact with the electrodes 32a and 32b, a fitting claw 52, an insulating ring 53 (refer to FIG. 10), a conductive member 54, and a cable 58. The internal surface of the cylindrical tube 24 of the fixing roller 12 and the end section of the heat generating resistive sheet 22 are tapered to have a larger size toward the outside respectively in a similar manner to that explained above. Therefore, when the heat generating resistive sheet 22 is provided to the fixing roller 12, it is possible to securely fit the heat generating resistive sheet 22 to the cylindrical tube without damaging the heat generating resistive sheet 22, and it is possible to securely feed current to the heat generating resistive sheet 22 that rotates.

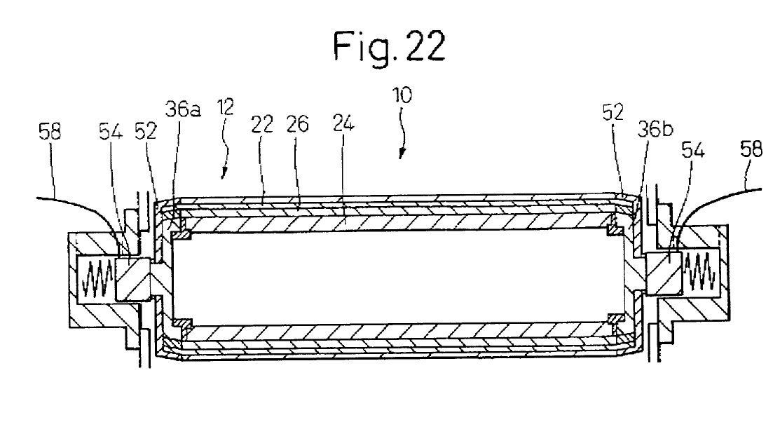

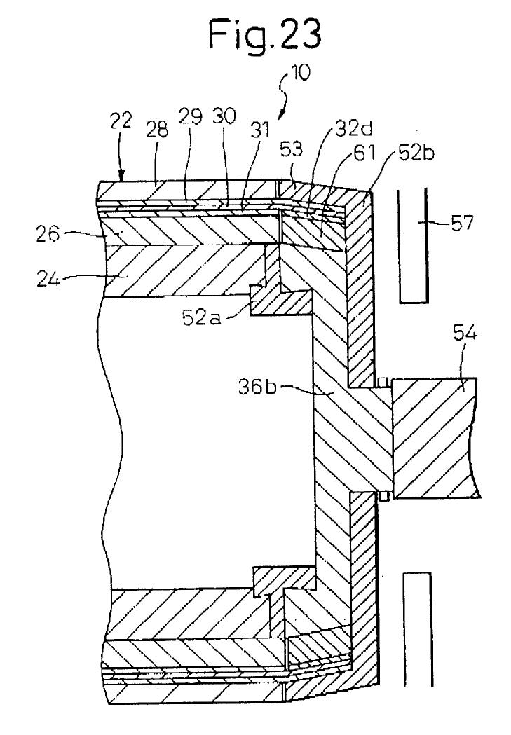

FIGS. 22 and 23 are cross-sectional views of a fixing apparatus according to a seventh embodiment of the present invention. The fixing apparatus 10 comprises a fixing roller 12 and a pressing roller 14 disposed contactably with the fixing roller 12, wherein the fixing roller 12 comprises a cylindrical tube 24 and a heat generating resistive sheet 22 provided on the surface of the cylindrical tube 24, like the fixing apparatus of the embodiment shown in FIG. 21. More specifically, in this embodiment, the fixing roller 12 comprises the cylindrical tube 24, a heat resistant elastic material layer 26 provided on the surface of the cylindrical tube 24, and the heat generating resistive sheet 22 provided on the surface of the elastic material layer 26.

The heat generating resistive sheet 22 comprises a metal layer 28, an insulating layer 29, a heat generating resistive layer 30, an insulating layer 31, electrodes 32a and 32b, and a releasing layer 33. A current feeding unit that feeds current to the electrodes 32a and 32b is similar to that shown in FIG. 16. That is, the current feeding unit comprises a first fitting claw 52a, conductive rings 36a and 36b, a second fitting claw 52b integrally formed with an insulating ring 60, a conductive member 54, and a cable 58.

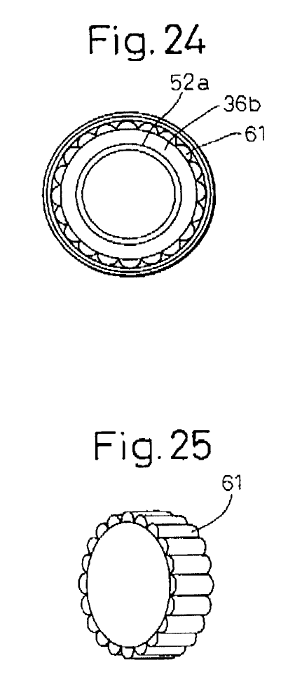

FIG. 24 is a cross-sectional view of the spring ring 60, and FIG. 25 is a perspective view of the spring ring 60. In this embodiment, a spring ring 61 is disposed between the elastic material layer 26 and the second fitting claw 52b in the axial direction, and between the electrode 32b and the conductive ring 36b in the radial direction. The spring ring 60 further ensures an electrical contact between the conductive ring 36b and the electrode 32b.

With this arrangement, it is possible to securely fit the heat generating resistive sheet 22 to the cylindrical tube without damaging the heat generating resistive sheet 22, and it is possible to securely feed current to the rotating heat generating resistive sheet 22.

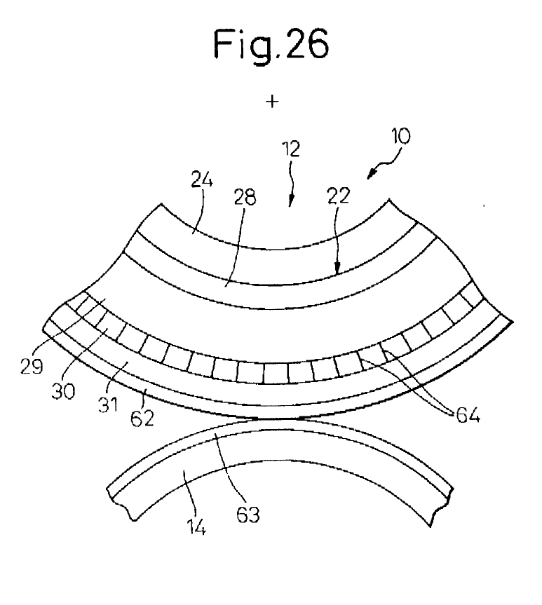

FIG. 26 is a cross-sectional view of a fixing apparatus according to an eighth embodiment of the present invention. The fixing apparatus 10 comprises a fixing roller 12 and a pressing roller 14 disposed contactably with the fixing roller 12, wherein the fixing roller 12 comprises a cylindrical tube 24 and a heat generating resistive sheet 22 provided on the surface of the cylindrical tube 24, like the fixing apparatus of the embodiment shown in FIG. 21. The fixing roller 12 comprises a cylindrical tube 24 and a heat generating resistive sheet 22 provided on the surface of the cylindrical tube 24.

The heat generating resistive sheet 22 comprises a metal layer 28, an insulating layer 29, a heat generating resistive layer 30, an insulating layer 31, and electrodes 32a and 32b. Further, a releasing layer 62 is provided on the insulating layer 31, and a releasing layer 63 is provided on the pressing roller 14. In this embodiment, the heat generating resistive layer 30 includes a mesh structure 64 so that resistance can change in the heat generating resistive layer 30.

FIG. 27 is an expanded view of the heat generating resistive sheet 22 shown in FIG. 26. The insulating layer 31 is on the heat generating resistive layer 30, and the electrodes 32a and 32b are on both ends of insulating layer 31.

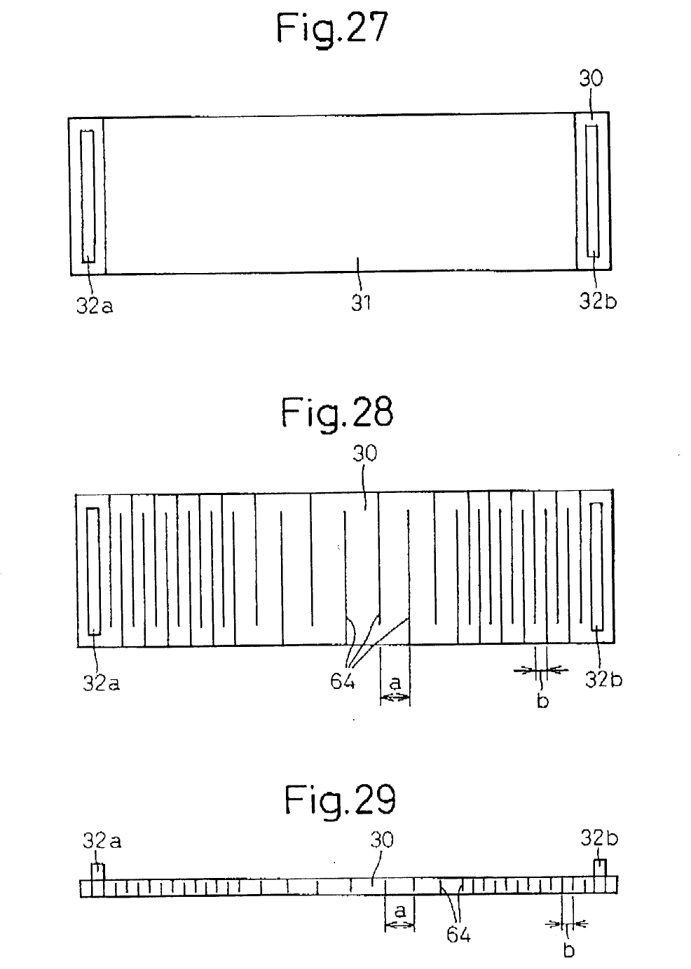

FIG. 28 is a top plan view of the heat generating resistive layer 30 of the heat generating resistive sheet 22 shown in FIG. 27. That is FIG. 28 is a top plan view of the heat generating resistive layer 30 that excludes the insulating layer 31 shown in FIG. 27. FIG. 29 is a cross-sectional view of the heat generating resistive layer 30 shown in FIG. 28.

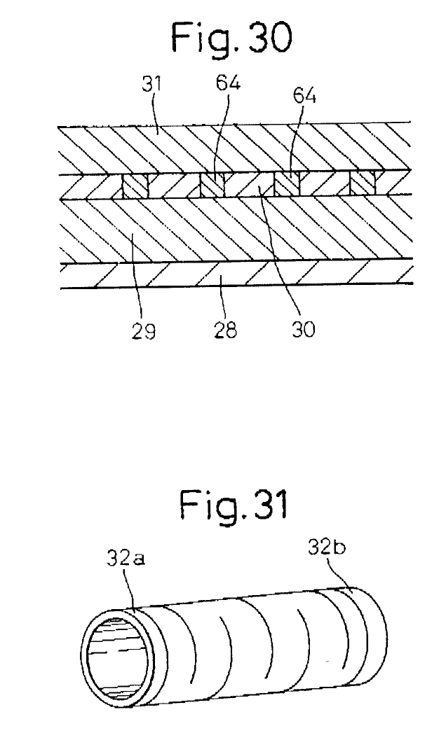

FIG. 30 is a partially-enlarged cross-sectional view of the heat generating resistive sheet 22 shown in FIG. 29. FIG. 31 is a schematic perspective view of the heat generating resistive layer 30 of the heat generating resistive sheet 22 shown in FIG. 26.

As shown in FIGS. 26 to 31, the heat generating resistive layer 30 includes the mesh structure 64. In the embodiment shown, the mesh structure 64 comprises slits formed in the heat generating resistive layer 30. A substance of a material (for example, a material of the insulating layers 29 and 31) that is different from a material of the heat generating resistive layer 30 is filled in the slits. Therefore, in the heat generating resistive layer 30, resistance changes between a portion where the material of the heat generating resistive layer 30 exists and a portion where there is no mesh structure 64. The mesh structure 64 is provided with different pitches along the longitudinal direction of the heat generating resistive layer 30. For example, in FIGS. 28 and 29, the mesh structure 64 is provided with a pitch “a”, around the center of the heat generating resistive layer 30. On the other hand, the mesh structure 64 is provided with a pitch “b” that are smaller than the pitch “a”, around the end section of the heat generating resistive layer 30 (a>b).

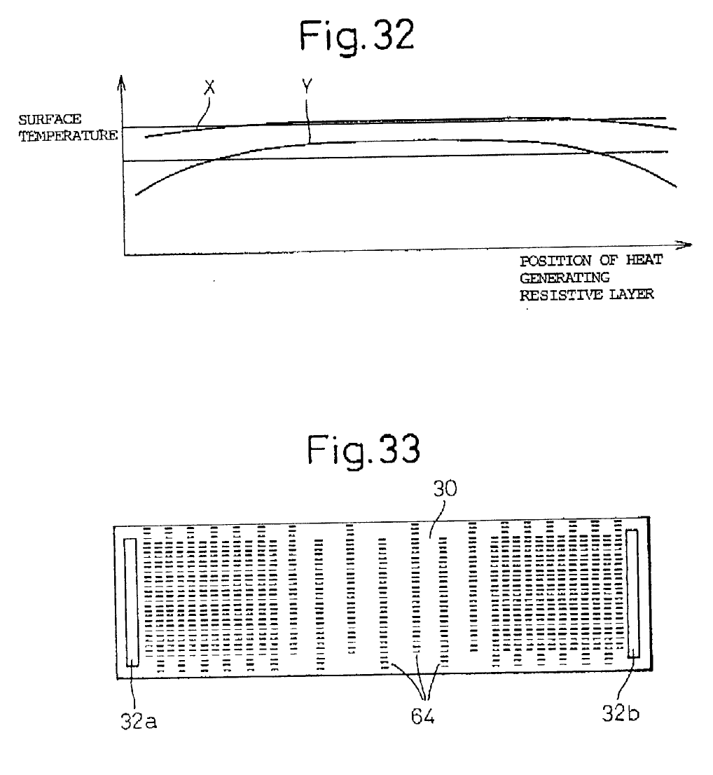

FIG. 32 is a view showing the temperature distribution of the heat generating resistive sheet 22. The curve X shows a temperature distribution of the heat generating resistive sheet 22 that includes the heat generating resistive layer 30 provided with the mesh structure 64. The curve Y shows a temperature distribution of the heat generating resistive sheet 22 that includes the heat generating resistive layer 30 of a uniform structure that has no mesh structure 64. In the curve Y, a difference between the temperature of the center section and the temperature of the end sections of the heat generating resistive layer 22 is substantially small. Therefore, when the heat generating resistive sheet 22 that includes the heat generating resistive layer 30 provided with the mesh structure 64 is used, it is possible to achieve uniform fixing over the whole surface of the paper.

FIG. 33 is a view showing a modification of the heat generating resistive layer 30. In FIGS. 28 and 31, the mesh structure 64 is provided with the pitches that continuously extend linearly in the circumferential direction of the roll-shaped heat generating resistive layer 30 and that are different in the longitudinal direction. In the example shown in FIG. 33, a mesh structure 64 is provided with pitches that discontinuously extend linearly in the circumferential direction of a roll-shaped heat generating resistive layer 30 and that are different in the longitudinal direction. It is also possible to provide mesh structures 64 based on various other methods.

As explained above, according to the present invention, it is possible to obtain a fixing apparatus having satisfactory heat efficiency, by improving the fixing performance, improving the paper detachment, shortening the fast printing time, and reducing the energy consumption. Further, it is possible to enlarge the non-offset margin and expand the luster margin, and it becomes possible to achieve on-demand printing, with reduced power consumption. Further, according to the present invention, it is also possible to securely feed electric current to the heat generating resistive sheet.

List of Reference Numbers

1 . . . fixing roller

2 . . . pressing roller

3 . . . halogen lamp

3a . . . halogen lamp

3b . . . halogen lamp

4 . . . silicone rubber layer

4a . . . silicone rubber layer

4b . . . silicone rubber layer

10 . . . fixing apparatus

12 . . . fixing roller

14 . . . pressing roller

16 . . . third roller

18 . . . fixing belt

20 . . . cylindrical tube

22 . . . heat generating resistive sheet

24 . . . cylindrical tube

26 . . . elastic material layer

28 . . . metal layer

29 . . . insulating layer

30 . . . heat generating resistive layer

31 . . . insulating layer

32a, 32b . . . electrodes

33 . . . releasing layer

34 . . . releasing layer

35 . . . releasing layer

36a, 36b . . . conductive ring

36c . . . projection

36d . . . air hole

37a, 37b . . . insulating layer

38 . . . oil roller

40 . . . oil roller cleaner

42 . . . thermistor

43 - - - spring

44 - - - spring

46 - - - spring

48 - - - spring

50 . . . bearing

51 . . . retaining ring

52 . . . fitting claw

53 . . . insulating ring

54 . . . conductive member

55 . . . spring

56 . . . holder

57 . . . frame

58 . . . cable

59 . . . retaining ring

60 . . . insulating ring

61 . . . spring ring

62 . . . releasing layer

63 . . . releasing layer

64 . . . mesh structure

1. A fixing apparatus comprising:
a fixing roller;
a pressing roller disposed contactably with the fixing roller;
a third roller disposed in parallel with the fixing roller; and
a fixing belt wound around the fixing roller and the third roller,
wherein the third roller includes a cylindrical tube and a heat generating resistive sheet provided on the surface of the cylindrical tube, and the fixing roller has a base cylindrical tube and an elastic material layer provided on the surface of the cylindrical tube.

2. The fixing apparatus according to claim 1, wherein the thickness of the elastic material layer of the fixing roller is at least 2 mm.

3. The fixing apparatus according to claim 1, wherein the cylindrical tube of the fixing roller comprises a metal hollow tube, and the elastic material layer is made of plastic or rubber.

4. The fixing apparatus according to claim 1, wherein the heat generating resistive sheet comprises a sheet having a laminated structure that includes a heat generating resistive layer, a metal layer, and an insulating layer disposed between the heat generating resistive layer and the metal layer.

5. A fixing apparatus comprising:
a fixing roller;
a pressing roller that is disposed contactably with the fixing roller;
a third roller disposed in parallel with the fixing roller; and
a fixing belt wound around the fixing roller and the third roller,
wherein the fixing belt comprises a heat generating resistive sheet, and the fixing roller has a cylindrical tube and an elastic material layer that is provided on the surface of the cylindrical tube.

6. The fixing apparatus according to claim 5, wherein the thickness of the elastic material layer is at least 2 mm.

7. The fixing apparatus according to claim 5, wherein the cylindrical tube of the fixing roller comprises a metal hollow tube, and the elastic material layer is made of plastic or rubber.

8. The fixing apparatus according to claim 5, wherein the heat generating resistive sheet comprises a sheet having a laminated structure that includes a heat generating resistive layer, a metal layer, and an insulating layer that is disposed between the heat generating resistive layer and the metal layer.

9. A fixing apparatus comprising:
a fixing roller;
a pressing roller disposed contactably with the fixing roller;
a third roller disposed in parallel with the fixing roller; and
a fixing belt wound around the fixing roller and the third roller,
whereon the third roller includes a cylindrical tube and a heat generating resistive sheet provided on the surface of the cylindrical tube, the heat generating resistive sheet having a heat generating resistive layer and electrodes connected to the heat generating resistive layer, and further includes conductive rings that are electrically brought into contact with the electrodes of the heat generating resistive sheet, and a portion that includes the electrode of the heat generating resistive sheet and the conductive ring are formed in a tapered shape respectively.

10. A fixing apparatus comprising:
a fixing roller;
a pressing roller disposed contactably with the fixing roller;
a third roller disposed in parallel with the fixing roller; and
a fixing belt wound around the fixing roller and the third roller,
wherein the fixing belt comprises a heat generating resistive sheet, the heat generating resistive sheet having a heat generating resistive layer and electrodes that are connected to the heat generating resistive layer, and further includes conductive rings that are electrically brought into contact with the electrodes of the heat generating resistive sheet, and a portion that includes the electrode of the heat generating resistive sheet and the conductive ring are formed in a tapered shape respectively.

11. A fixing apparatus comprising:
a fixing roller; and
a pressing roller disposed contactably with the fixing roller,
wherein the fixing roller comprises a cylindrical tube and a heat generating resistive sheet provided in the cylindrical tube, the heat generating resistive sheet having a heat generating resistive layer and electrodes that are connected to the heat generating resistive layer, and further includes conductive rings that are electrically brought into contact with the electrodes of the heat generating resistive sheet, and an insulating ring is disposed between the cylindrical tube and the conductive ring.

12. A fixing apparatus comprising:
a fixing roller; and
a pressing roller disposed contactably with the fixing roller,
wherein the fixing roller comprises a cylindrical tube, a heat generating resistive sheet provided in the cylindrical tube, and an elastic material layer, the heat generating resistive sheet having a heat generating resistive layer and electrodes connected to the heat generating resistive layer, and further includes conductive rings that are electrically brought into contact with the electrodes of the heat generating resistive sheet, and a portion that includes the electrode of the heat generating resistive sheet and the conductive ring are formed in a tapered shape respectively.

13. A fixing apparatus comprising:
a fixing roller; and
a pressing roller disposed contactably with the fixing roller,
wherein the fixing roller comprises a cylindrical tube, a heat generating resistive sheet provided in the cylindrical tube, and an elastic material layer, the heat generating resistive sheet having a heat generating resistive layer and electrodes connected to the heat generating resistive layer, and further includes conductive rings that are electrically brought into contact with the electrodes of the heat generating resistive sheet, and an elastic conductive material is disposed between the electrode of the heat generating resistive sheet and the conductive ring.

14. A fixing apparatus comprising:
a fixing roller; and
a pressing roller disposed contactably with the fixing roller,
wherein the fixing roller comprises a cylindrical tube and a heat generating resistive sheet provided in the cylindrical tube, the heat generating resistive sheet has a heat generating resistive layer and insulating layers that are disposed at both sides of the heat generating resistive layer, and the heat generating resistive layer has a mesh structure in order to change the distribution of resistance.
